(19) United States
(12) Patent Application Publication
(10) Pub. No.: US 2012/0314890 A1
(43) Pub. Date: Dec. 13, 2012

(54) WIRELESS HEARING ASSISTANCE SYSTEM AND METHOD

(75) Inventors: Amre El-Hoiydi, Neuchatel (CH); Christoph Schmid, Zimmerwald (CH); Timothée Jost, Auvernier (CH); Rainer Platz, Colombier (CH); Marc Secall, Constantine (CH)

(73) Assignee: PHONAK AG, Staefa (CH)

(21) Appl. No.: 13/577,983

(22) PCT Filed: Feb. 12, 2010
(86) PCT No.: PCT/EP2010/051815

§ 371 Date: Aug. 9, 2012

(51) Int. Cl. H04R 25/00

(52) U.S. Cl. 381/315

(57) ABSTRACT

A hearing assistance system having a plurality of transmission units, a microphone arrangement and a digital transmitter for transmitting audio signals as audio data packets via a wireless digital audio link; at least one user worn receiver unit; a relay unit with a mixing unit for producing a mixed audio signal from audio signals received and at least one digital transceiver for receiving audio signals from the transmission units via the digital audio link and for transmitting the mixed audio signal via the wireless digital audio link as audio data packets to a digital receiver of the receiver unit(s) for stimulating the hearing of the user(s) according to audio signals supplied from the receiver unit, the relay unit and each transmission unit transmitting each audio data packet in at least one allocated separate slot of a TDMA frame at a different frequency according to a frequency hopping sequence.

### BACKGROUND OF THE INVENTION

1. Field of the Invention

The invention relates to a system and a method for providing hearing assistance to at least one user, wherein audio signals from a plurality of wireless microphones, typically used for capturing the voice of speaker using the respective microphone, are transmitted via a wireless link to a relay unit, where the audio signals are mixed and from where a mixed audio signal is transmitted via the wireless link to a at least one receiver unit, such as an audio receiver for a hearing aid, from where the audio signals are supplied to means for stimulating the hearing of the user, such as a hearing aid loudspeaker.

2. Description of Related Art

Presently, in hearing assistance systems comprising a wireless microphone the wireless audio link usually is an FM (frequency modulation) radio link. According to a typical application of such wireless audio systems the receiver unit is connected to or integrated into a hearing instrument, such as a hearing aid, with the transmitted audio signals being mixed with audio signals captured by the microphone of the hearing instrument prior to being reproduced by the output transducer of the hearing instrument. The benefit of such systems is that the microphone of the hearing instrument can be supplemented or replaced by a remote microphone which produces audio signals which are transmitted wirelessly to the FM receiver and thus to the hearing instrument. Their merit lies in the fact that a microphone placed a few centimeters from the mouth of a person speaking receives speech at a much higher level than one placed several feet away. This increase in speech level corresponds to an increase in signal-to-noise ratio (SNR) due to the direct wireless connection to the listener's amplification system. The resulting improvements of signal level and SNR in the listener's ear are recognized as the primary benefits of FM radio systems, as hearing-impaired individuals are at a significant disadvantage when processing signals with a poor acoustical SNR.

Examples of analog wireless FM systems particularly suited for school applications are described, for example, in European Patent Application EP 1 863 320 A1 and International Patent Application Publication WO 2008/138365 A1. According to these systems, the wireless link not only serves to transmit audio signals captured by the wireless microphone, but in addition, also serves to transmit control data obtained from analyzing the audio signals in the transmission unit to the receiver unit(s), with such control data being used in the receiver unit to adjust, for example, the gain applied to the received audio signals according to the prevailing ambient noise and the issue of whether the speaker is presently speaking or not.

In applications where the receiver unit is part of or connected to a hearing aid, transmission is usually carried out by using analog FM technology in the 200 MHz frequency band. In recent systems, the analog FM transmission technology is replaced using digital modulation techniques for audio signal transmission. An example of such digital system is available from the company Comfort Audio AB, 30105 Halmstad, Sweden under the COMFORT DIGISYSTEM® trademark.

U.S. Patent Application Publication 2002/0183087 A1 and corresponding U.S. Pat. No. 7,103,340 B2 relate to a Bluetooth link for a mobile phone using two parallel antennas/transceivers, wherein each data packet is sent once, and wherein for a sequence of packets, usually for the next 8 packets, a certain one of the antennas is selected according to previous channel quality measurements as a function of frequency. For each packet of the sequence, one of the antennas is selected depending on the respective frequency at which the packet is to be transmitted, wherein the frequency is determined by a frequency hopping sequence.

U.S. Patent Application Publication 2006/0148433 A1 and corresponding U.S. Pat. No. 7,489,913 B2 relate to a wireless link between a mobile phone and a base station of the mobile network, wherein two receivers are used in parallel for achieving diversity if the coverage is poor. Canadian Patent 2 286 522 C relates to a diversity radio reception method, wherein two data packets received in parallel by two receivers are compared and, if they differ from each other, the more reliable one is selected for further processing. In “Effect of Antenna Placement and Diversity on Vehicular Network Communications” by S. Kaul, K. Ramachandran, P. Shankar, S. Oh, M. Gruteser, I. Seskar, T. Nadeem, 4^{th} Annual IEEE Communications Society Conference on Sensor, Mesh and Ad Hoc Communications and Networks, 2007, SECON '07, pp. 112-121, a packet level diversity approach is described, wherein in a vehicle-to-vehicle link using roof- and in-vehicle-mounted omni-directional antennas and IEEE 802.11a radios operating in the 5 GHz band a packet level selection diversity scheme using multiple antennas and radios is utilized to improve performance not only in a fading channel but also in line-of-sight conditions. A similar approach is used in “Packet-Level Diversity—From Theory to Practice: An 802.11-based Experimental Investigation” by E. Vergetis et al., MobiCom '06, wherein a packet level diversity scheme is applied to a wireless data link between a laptop computer and an access point.

A presentation by S. Shellhammer “SCORT—An Alternative to the Bluetooth SCO Link for Voice Operation in an Interference Environment” document IEEE 802.15-01/145r1, March 2001, and of the IEEE P802.15 Working Group for Wireless Personal Area Networks, relate to a proposed alternative for the Bluetooth SCO link for operation in an interference environment, wherein it is proposed to use, in a bi-directional point-to-point link (i.e., full duplex link) for voice transmission, repeated transmission of the same audio packet without involving a receipt acknowledgement by the receiving device.

U.S. Patent Application Publication 2007/0009124 A1 and corresponding U.S. Pat. No. 7,778,432 B2 relate to a wireless network for communication of binaural hearing aids with other devices, such as a mobile phone, using slow frequency hopping, wherein each data packet is transmitted in a separate slot of a TDMA frame, with each slot being associated to a different transmission frequency, wherein the hopping sequence is calculated using the ID of the master device, the slot number and the frame number. A link management package is sent from the master device to the slave devices in the first slot of each frame. The system may be operated in a broadcast mode. Each receiver is turned on only during the transmission during time slots associated to the respective receiver. The system has two acquisition modes for synchronization, with two different handshake protocols. Eight LMP messages are transmitted in every frame during initial acquisition, and one LMP message is transmitted in every frame once a network is established. Handshake, i.e., bi-directional message exchange, is needed both for initial acquisition and acquisition into the established network. During acquisition, only a reduced number of acquisition channels is used, with the frequency hopping scheme being applied to these acquisition channels. The system operates in the 2.4 GHz ISM band. A similar system is known from U.S. Patent Application Publication 2009/0245551 A1 and corresponding U.S. Pat. No. 8,229,146 B2.

U.S. Pat. No. 7,529,565 B2 relates to a hearing aid comprising a transceiver for communication with an external device, wherein a wireless communication protocol including a transmission protocol, link protocol, extended protocol, data protocol and audio protocol is used. The transmission protocol is adapted to control transceiver operations to provide half duplex communications over a single channel, and the link protocol is adapted to implement a packet transmission process to account for frame collisions on the channel.

U.S. Patent Application Publica 2006/0067550 A1 relates to a hearing aid system comprising at least three hearing aids between which a wireless communication network is established using the Bluetooth standard, wherein one of the hearing aids is used for receiving signals from another one of the hearing aids, amplifying the signals and forwarding it to the third hearing aid.

U.S. Patent Application Publication 2007/0086601 A1 relates to a system comprising a transmission unit with a microphone for transmitting a speaker's voice to a plurality of hearing aids via a wireless digital link, which may be unidirectional or bi-directional and which may be used for transmitting both audio data and control data to the hearing aids.

International Patent Application Publication WO 2008/074350 A1 relates to an analog wireless FM system, particularly suited for school applications, wherein the system consists of a plurality of transmission units comprising a microphone and a plurality of analog FM receiver units and wherein only one of the transmission units has an analog audio signal transmitter, while each of the transmission units is provided with a digital transceiver in order to realize an assistive digital link for enabling communication between the transmission units. The assistive digital link also serves to transmit audio signals captured by a transmission unit not having the analog transmitter to the transmission unit having the analog transmitter from where the audio signals are transmitted via the analog FM link to the receiver units.

U.S. Pat. No. 5,966,639 relates to a hearing assistance system comprising a plurality of wireless microphone units, a relay unit and ear-level receiver units, wherein each microphone unit is worn by another speaker, for example, as a lapel or shirt collar microphone, wherein the audio signals transmitted from the microphone units are received and mixed by the relay unit and forwarded to the receiver units, and wherein each audio stream, namely the streams from the microphone units to the relay unit and the stream from the relay unit to the receiver unit, is transmitted on a FM-channel having a fixed frequency which is distinct from the frequency of the other channels. According to an alternative embodiment, the microphone units form a repeater chain, with the audio streams being forwarded from microphone unit to microphone unit and being mixed accordingly, with the final microphone unit transmitting the mixed audio signal to the ear-level receiver units.

International Patent Application Publication WO 2005/086801 A2 relates to a hearing assistance system comprising a plurality of wireless microphone units worn by different speakers and a receiver unit worn at a loop around a listener's neck, with the sound being generated by a headphone connected to the receiver unit, wherein audio signals are transmitted from the microphone unit to the receiver unit by using a spread-spectrum digital signal. The receiver unit controls the transmission of data, and the receiver unit also controls the pre-amplification gain level applied in each microphone unit by sending respective control signals via the wireless link. Mixing of the received audio signals is controlled such that the signal with the highest audio power is amplified with unity gain, and the other signals are attenuated by 6 dB. A corresponding product is available from Etymotic Research, Inc. of Elk Grove Village, Ill., USA.

U.S. Pat. No. 4,920,570 relates to a hearing assistance system comprising a relay unit and an earphone module, wherein the relay unit is provided for relaying audio signals from one of a plurality of remote input devices towards the earphone module, wherein the audio signals to and from the relay unit are transmitted via an analog or digital audio link. One or more of the signals transmitted from the remote input devices may be selected to form a selected signal.

International Patent Application Publication WO 2008/151624 A1 relates to a hearing assistance system comprising a plurality of hearing aids worn by different users, wherein each hearing aid or pair of hearing aids is provided with a relay device to be carried by the user of the respective hearing aid(s). The relay device may comprise one or more microphones and serves to establish communication within a group of hearing aids via the relay devices, with audio signals and other data being exchanged between the relay devices. The relay devices of a group may directly communicate with each other via digital wireless links; also the link between the relay device and its associated hearing aid is digital. International Patent Application Publication WO 2008/151623 A1 relates to a similar system.

U.S. Patent Application Publication 2004/0185773 A1 and corresponding U.S. Pat. No. 7,062,223 B2 relate to a hearing assistance system comprising a relay unit which receives audio signals from remote audio input devices, such as a microphone, a mobile phone, a TV set, etc. and which selects one of these input audio signals for being forwarded via a wireless audio link to an ear-level receiver unit.

U.S. Patent Application Publication 2006/0039577 A1 relates to a hearing assistance system comprising a relay unit and a hearing aid with a receiver unit, wherein the relay unit is worn around the neck of the hearing aid user and serves to receive audio signals from remote devices, such as mobile phone, via a Bluetooth link and to relay such audio signals via an inductive link to the hearing aid receiver unit.

### SUMMARY OF THE INVENTION

It is an object of the invention to provide for a hearing assistance system comprising a plurality of wireless microphones and at least one receiver unit, wherein the receiver unit should be adapted to be worn at ear-level and wherein audio signal transmission and processing should be relatively simple and user-friendly, so that speech intelligibility for a group of speakers, can be enhanced in an efficient manner. It is also an object to provide for a corresponding hearing assistance method.

According to the invention, these objects are achieved by a hearing assistance system and a hearing assistance method as disclosed herein.

The invention is beneficial in that, by providing a relay unit for mixing the audio signals received from the transmission units and for forwarding the mixed audio signal to the receiver unit(s), ear-level design of the receiver unit is enabled, which otherwise would be prevented by the relatively high power consumption necessary for receiving several audio streams in parallel. The invention is further beneficial in that, by implementing the wireless audio link in a manner that each audio data packet is transmitted in an allocated separate slot of a TDMA frame at a different frequency selected according to a frequency-hopping sequence, a simple, user-friendly and flexible audio channel handling is achieved.

These and further objects, features and advantages of the present invention will become apparent from the following detailed description when taken in connection with the accompanying drawings which, for purposes of illustration only, show several embodiments in accordance with the present invention.

### BRIEF DESCRIPTION OF THE DRAWINGS

FIG. 1 is a schematic view of a first example of a hearing assistance system according to the invention, including an example of a TDMA schedule;

FIG. 2 is an illustration of a schematic example of the audio signal path in a transmission unit of the system of FIG. 1;

FIGS. 3 to 5 are illustrations of different examples of the audio signal path in a relay unit of the system of FIG. 1;

FIG. 6 is an illustration of a schematic example of the audio signal path of a receiver unit of the system of FIG. 1;

FIG. 7 is an illustration of schematic example of the audio signal path in a second example of a hearing assistance system according to the invention;

FIG. 8 is an illustration of a schematic example of the audio signal path in a combined transmission/receiver unit;

FIG. 9 is an example of a TDMA frame structure of the digital audio link used in a system according to the invention;

FIG. 10 is an example of the protocol of the digital audio link used in a system according to the invention in the connected state;

FIG. 11 is an illustration of an example of the protocol of the digital audio link used in an example of a hearing assistance system according to the invention comprising a plurality of receiver units;

FIG. 12 is an illustration of an example of how a receiver unit in a system according to the invention listens to the signals transmitted via the digital audio link;

FIG. 13 is an illustration of an example of a frequency-hopping scheme used in a system according to the invention;

FIG. 14 is an illustration of the communication in a system according to the invention during synchronization of the digital link;

FIG. 15 is an illustration of antenna diversity in the relay unit of a system according to the invention;

FIG. 16 is a further illustration of an example of a packet level diversity scheme used in the relay unit of a system according to the invention.

### DETAILED DESCRIPTION OF THE INVENTION

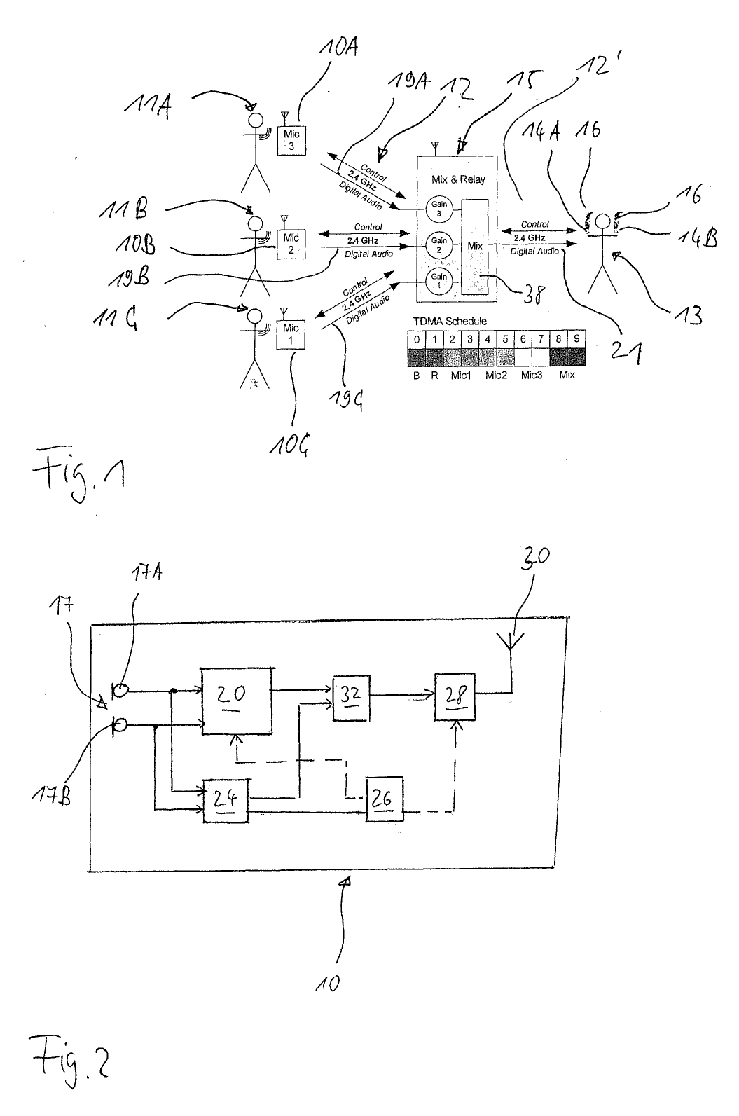

The hearing assistance system shown in FIG. 1 comprises a plurality of transmission units 10A, 10B, 10C, a relay unit 15, and two receiver units, 14A connected to a right-ear hearing aid 16 and 14B connected to a left-ear hearing aid 16 worn by a hearing impaired listener 13.

Each transmission unit 10 comprises a microphone arrangement 17 for capturing audio signals from the respective speaker's 11 voice, an audio signal processing unit 20 for processing the captured audio signals, a digital transmitter 28 and an antenna 30 for transmitting the processing audio signals as an audio stream 19 composed of audio data packets to the relay unit 15 (in FIG. 1, the audio stream from the transmission unit 10A is labeled 19A, the audio stream from the transmission unit 10B is labeled 19B, etc.). The audio streams 19A, 19B, etc. form part of a digital audio link 12 established between the transmission units 10 and the relay unit 15, which link also serves to exchange control data packets between the relay unit 15 and the transmission units 10. The transmission units 10 may include additional components, such as a voice activity detector (VAD) 24. The audio signal processing unit 20 and such additional components may be implemented by a digital signal processor (DSP) indicated at 22. In addition, the transmission units 10 also may comprise a microcontroller 26 acting on the DSP 22 and the transmitter 28. The microcontroller 26 may be omitted in case that the DSP 22 is able to take over the function of the microcontroller 26.

Preferably, the microphone arrangement 17 comprises at least two spaced-apart microphones 17A, 17B, the audio signals of which may be used in the audio signal processing unit 20 for acoustic beam-forming in order to provide the microphone arrangement 17 with a directional characteristic.

The VAD 24 uses the audio signals from the microphone arrangement 17 as an input in order to determine the times when the person 11 using the respective transmission unit 10 is speaking. The VAD 24 may provide a corresponding control output signal to the microcontroller 26 in order to have, for example, the transmitter 28 sleep during times when no voice is detected and to wake up the transmitter 28 during times when voice activity is detected. In order to maintain synchronization with the master device—usually the relay unit 15 and also during times when the speaker 11 is not speaking. The transmitter 28 of that transmission unit 10 is adapted to also wake up at least during some times when reception of beacon packets from the master device is to be expected; this will be explained in more detail below.

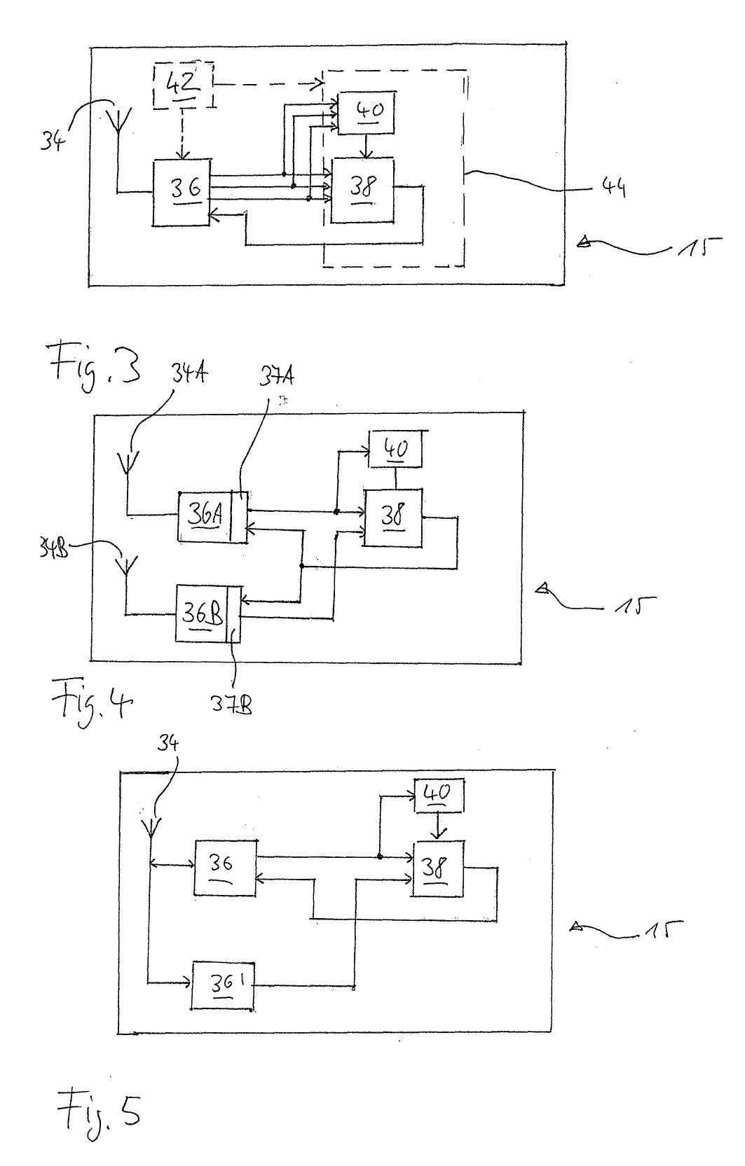

In addition, an appropriate output signal of the VAD 24 may be transmitted via the wireless link 12. To this end, a unit 32 may be provided which serves to generate a digital signal comprising the audio signals from the processing unit 20 and the control data generated by the VAD 24, which digital signal is supplied to the transmitter 28. In addition to the VAD 24, the transmission unit 10 may comprise an ambient noise estimation unit (not shown in FIG. 2) which serves to estimate the ambient noise level and which generates a corresponding output signal which may be supplied to the unit 32 for being transmitted via the wireless link 12.

In practice, the digital transmitter 28 is designed as a transceiver, so that it cannot only transmit data from the transmission unit 10 to the relay unit 15 but also receive control data and commands sent from the relay unit 15, as will be explained in more detail below.

According to one embodiment, the transmission units 10 may be adapted to be worn by the respective speaker 11 below the speaker's neck, for example, as a lapel microphone or as a shirt collar microphone.

The relay unit 15, according to the example shown in FIG. 3, comprises an antenna 34, a digital transceiver 36, a mixing unit 38, an audio signal analyzer unit 40 and a microcontroller 42. The mixing unit 38 and the analyzer unit 40 may be implemented by a DSP 44. The microcontroller 42 acts to control the digital transceiver 36 and the DSP 44. The audio signal streams 19A, 19B, 19C transmitted from the transmission units 10A, 10B, 10C via the link 12 are received via the antenna 34 by the transceiver 36 and are demodulated into respective output signals which are supplied as separate signals, i.e., as three audio streams, to the mixing unit 38 which mixes the audio streams into a mixed output signal as a weighted sum of the audio signal streams. The analyzer unit 40 serves to analyze the received audio signal streams in order to determine the weights of the audio signal streams to be applied in the mixing unit 38. For example, the analyzer unit 40 may determine the weights of the audio signal streams according to a measurement of the average signal power of each audio signal stream, a measurement of a SNR of each audio signal stream and/or voice activity detection. The mixed output audio signal is supplied from the mixing unit 38 to the transceiver 36 for being transmitted as a digital audio stream 21 which forms part of a wireless audio link 12′ to the receiver unit 14.

An example of the audio signal paths in the receiver unit 14 is shown in FIG. 6. The receiver unit 14 comprises an antenna 46, a digital receiver 48, a DSP 50 acting as a processing unit which separates the received signals into the audio signals and the control data and which is provided for advanced processing, e.g., equalization of the audio signals according to the information provided by the control data, and a memory 54 for the DSP 50. The processed audio signals, after digital to analog conversion, are supplied to an amplifier 52 which may be a variable amplifier serving to amplify the audio signals by applying a gain controlled by the control data received via the digital link 12′. The amplified audio signals are supplied to a hearing aid 16 which includes an output transducer (typically a loudspeaker 68) for stimulating the user's hearing. Alternatively, the variable gain amplifier may be realized in the digital domain by using a PWM (pulse width modulation) modulator taking over the role of the D/A-converter and the power amplifier.

Rather than supplying the audio signals amplified by the amplifier 52 to the input of a hearing aid 16, the receiver unit 14 may include a power amplifier 56 which may be controlled by a manual volume control 58 and which supplies power amplified audio signals to a loudspeaker 60 which may be an ear-worn element integrated within or connected to the receiver unit 14. The receiver unit 14 also may include a microcontroller (not shown) for controlling the DSP 50 and the receiver 48. Alternatively, this role could be taken over by the DSP 50.

The receiver 48 in practice is implemented as a transceiver, in order to allow control data exchange between the relay unit 15 and the receiver unit 14 via the digital link 12′.

Usually, the relay unit 15 will act as a master device and the transmission units 10 and the receiver units 14 act as slave devices. To this end, the relay unit 15 sends the necessary control data via the digital link 12, 12′ to the slave devices. For example, a beacon packet may be transmitted from the relay unit 15 in the first slot of each TDMA frame which contains information for hopping frequency synchronization and which may also contain information relevant for the audio streams 19A, 19B, 19C, 21, such as description of encoding format, description of audio content, gain parameter, surrounding noise level, information relevant for multi-talker network operation, and/or control data for all or a specific one of the transmission units 10 and/or the receiver unit 14.

Preferably, the digital audio link 12, 12′ is established at a carrier-frequency in the 2.4 GHz ISM band.

The system shown in FIG. 1 may be used by three non-hearing-impaired persons 11A, 11B, 11C equipped with the transmission units 10A, 10B, 10C acting as a wireless microphone and one hearing-impaired person 13 equipped with the hearing aids 16 and the ear-level receiver units 14A, 14B. The relay unit 15 receives the audio streams 19A, 19B, 19C from the microphones 17 of the transmission units 10A, 10B, 10C, combines the audio signals and forwards the combined audio signal as audio stream 21 to the ear level aid receiver units 14A, 14B.

An example of a TDMA schedule of the link 12, 12′ is shown at the bottom of FIG. 1. Beacons may be transmitted in time slot #0 by the master (i.e., the relay unit 15) to the slaves (transmission units 10 and receiver units 14). Responses to queries transmitted by the master within the beacon may be sent in slot #1 by the slaves. Slots #2 and 3 may be allocated to audio data packets from the transmission unit 10A, slots #4 and 5 may be allocated to audio data packets from the transmission unit 10B, and slots #6 and 7 may be allocated to audio data packets from the transmission unit 10C. Slots #8 and 9 may be allocated to transmission of the audio data packets of the mixed audio stream 21 from the relay unit 15 to the receiver units 14A, 14B. More details regarding the protocol will be given below.

Alternatively, slot #0 may be shared by beacons and responses by time multiplexing, thus leaving room, for example, for an additional slot for the transmission of the mixed audio signal in order to enhance redundancy and robustness of this signal.

Typically, the TDMA schedule is structured for unidirectional broadcast transmission of the audio data packets from the relay unit, without individually addressing the receiver units 14, wherein the same audio packet of the mixed audio signal is transmitted preferably at least twice in the same TDMA frame (in the example of FIG. 1 in slots #8 and 9), without expecting acknowledgement messages from the receiver units 14. Preferably, the TDMA schedule is structured also for unidirectional broadcast transmission of the audio data packets from the transmission units 10, without individually addressing the relay unit 15 (or the receiver units 14), wherein preferably the same audio data packet of each of the transmission units 10 is to be transmitted at least twice in the same TDMA frame (in the example of FIG. 1, see e.g., slots #2 and 3 for the transmission unit 10A), without expecting acknowledgement messages from the relay unit 15. Preferably, as shown in the example of FIG. 1, the same audio data packet is to be transmitted at least twice in subsequent slots.

For the link 12 between the transmission units 10 and the relay unit 15, in principle, repetition of audio data packets could be occur on demand, since it is a point-to-point link. However, the above described repetition in advance is preferred also for this link due to audio latency reasons and capacity reasons (sending a global acknowledgement in the beacon would add delay, sending an acknowledgment after each audio packet would consume capacity).

Preferably, the TDMA slots are allocated in such a manner that the same number of audio data packets per frame is available for each transmission unit 10 and that also for the relay unit 15 at least the same number of audio data packet slot per frame is available. Typically, the TDMA schedule is kept constant, i.e., the allocation of the slots to the audio data packets is the same for each frame.

Allocation of the slots is performed by the relay unit 15 by transmitting respective beacon packets. In case that more transmission units 10 are used than can be handled simultaneously by the TDMA schedule (in the example of FIG. 1, only three transmission units 10 can be handled), audio channels, i.e., TDMA slots, may be allocated to the transmission units on a dynamic basis via signaling through the beacon and response slots. Allocation of channels is transmitted in the beacon, while resource requests from the transmission units 10 are transmitted in the response slot to the relay unit. In this manner, for example, an audio channel may be allocated to that one of the transmission units 10 which has found via the VAD 24 that the respective speaker 11 is presently speaking.

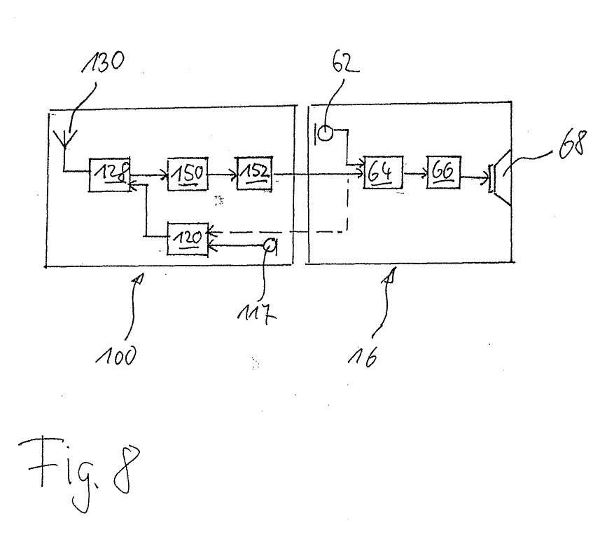

An alternative solution to this problem is shown in FIG. 5, wherein a second transceiver 36′ is provided in addition to the transceiver 36, which may use the same antenna 34 as the transceiver 36 or a separate antenna (not shown in FIG. 5; also, FIG. 5 does not illustrate the multiple audio streams supplied to the mixing unit 38 as shown in FIG. 3). Thereby a supplementary wireless digital audio link may be established in parallel to the (main) audio link described above, in order to transmit audio signals from the relay unit 15 to those receiver units 10 which cannot use the main audio link due to capacity reasons. The frequency hopping scheme applied to the TDMA slots of the supplementary audio link has to be such that the frequency used in the present slot of the supplementary audio link is always different from the frequency used in the present slot of the main audio link. For example, the presently used frequency of the supplementary audio link may correspond to the frequency used in the previous TDMA slot of the main audio link.

While typically the relay unit 15 will do the mixing of the received audio signals in such a manner that the audio signals from that transmission unit 10 whose speaker is presently speaking are prioritized, mixing also may occur in a manner that spatial hearing by the listener 13 is promoted. This can be done by ensuring that different (mixed) audio signals are transmitted to the right ear receiver unit 14A and to the left ear receiver unit 14B. Such mixing of audio signals from different sources, i.e., microphones, in order to enable spatial hearing of a hearing impaired person is described, for example, in International Patent Application Publication WO 2008/098590 A1. By such methods, perception of the relative spatial positions of microphones and ear-worn receiver units by the hearing impaired person may be made to approximately correspond to what a non-hearing impaired person would perceive with direct sound.

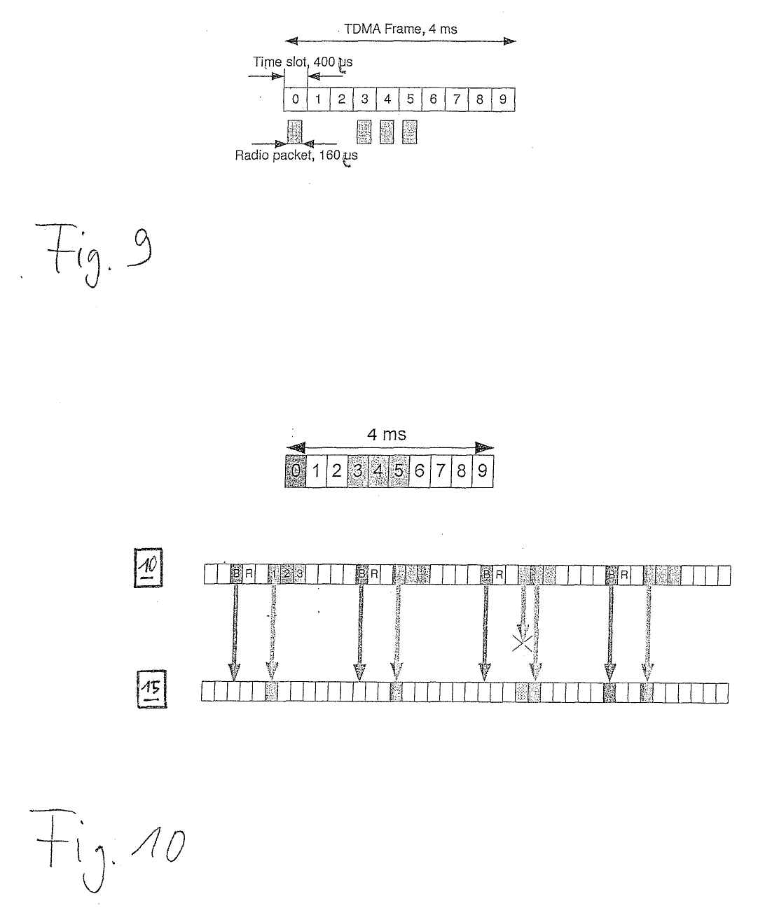

An alternative configuration of a system according to the invention is shown in FIG. 7, wherein all speakers 11 using one of the transmission units 10 also are listeners and thus wear one or two of the hearing aids 16 and the respective receiver units 14; i.e., in the example of FIG. 7, the system is designed for communication among a plurality of hearing impaired persons equipped both with a transmission unit 10 and a hearing aid 16 with receiver unit 14. The transmission units 10 are used in the same manner as in the system of FIG. 1: audio signals captured from the respective speaker's 11 voice are transmitted via the wireless audio link 12 to the relay unit 15 as audio streams 19A, 19B, 19C, where they are mixed in the mixing unit 38, with the mixed audio output signal being transmitted from the relay unit 15 via the wireless link 12′ as an audio stream 21 to the receiver units 14 worn by the speakers 11A, 11B, 11C, respectively. Usually the same mixed audio signal is supplied to all receiver units 14.

The audio links 12, 12′ are also used for transmitting beacons from the master device, i.e., the relay unit 15, to the slave devices, i.e., the transmission units 10 and the receiver units 14, while the slave devices may transmit responses to the master device (such control data exchange is not shown in FIG. 7).

Of course, also modified applications of the system of FIG. 7 are possible, for example, only some of the speakers 11 may wear hearing aids 16 or only some of the hearing aid users may also use a transmission unit 10.

As a variant, the functionality of the transmission unit 10 may be integrated into the hearing aid 16 (or the respective receiver unit 14). An example of such an embodiment is shown in FIG. 8. A transceiver unit 100 combining the functionality of one of the transmission units 10 and one of the receiver units 14 of the embodiments of FIG. 1 or 7 is connected to a hearing aid 16. The hearing aid comprises a microphone arrangement 62 (which usually comprises at least two spaced apart microphones), an audio signal processing unit 64, a power amplifier 66 and a loudspeaker 68. The microphone arrangement 62 is provided for picking-up ambient sound. The transceiver unit 100 comprises an antenna 130, a transceiver 128, a first audio signal processing unit 150, a second audio signal processing unit 120, an amplifier 152 and a microphone arrangement 117.

The antenna 130 and the transceiver 128 serve to receive audio signals from the relay unit 15, which audio signals are processed in the first processing unit 150 and are amplified by amplifier 152 prior to being supplied to the processing unit 64 of the hearing aid 16. The microphone arrangement 117 serves to capture audio signals from the voice of the person wearing the transceiver unit 100 and the hearing aid 16, with the captured audio signals being supplied to the second processing unit 120, from where the processed audio signals are supplied to the transceiver 128 for being transmitted via the antenna 130 to the relay unit 15. Also the audio signals captured by the microphone arrangement 62 of the hearing aid 16 may be supplied as an additional input signal to the second processing unit 120. Since the transceiver unit 100 is to be worn at ear-level, the microphone arrangement 117 may be a bone conduction microphone for capturing the user's voice. As an additional input signal, the audio signals captured by the hearing aid microphone arrangement 62 may be supplied to the second processing unit 120. For example, a blind source separation (BSS) algorithm may be applied in the second processing unit 120 for separating the user's voice from background noise/ambient noise (examples of such voice pick-up systems are found in International Patent Application Publication WO 2007/073818 A1).

Rather than being designed as a separate device, the transceiver unit 100 may be functionally integrated within the hearing aid 16.

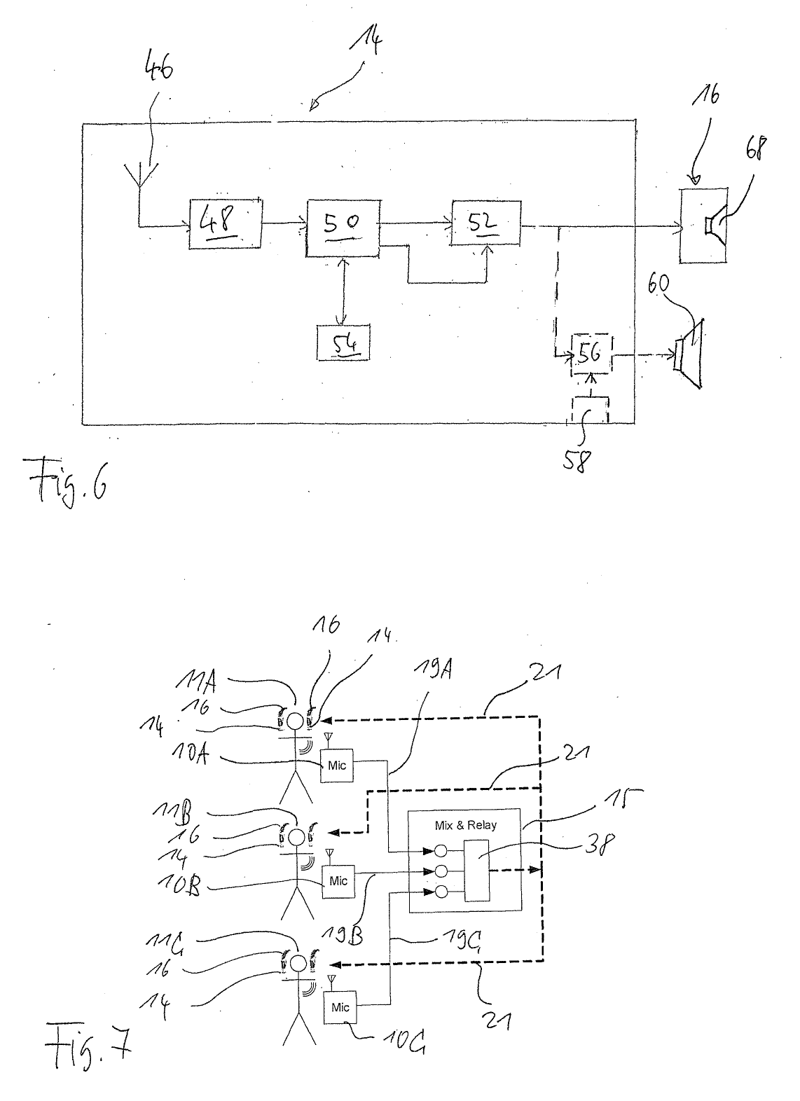

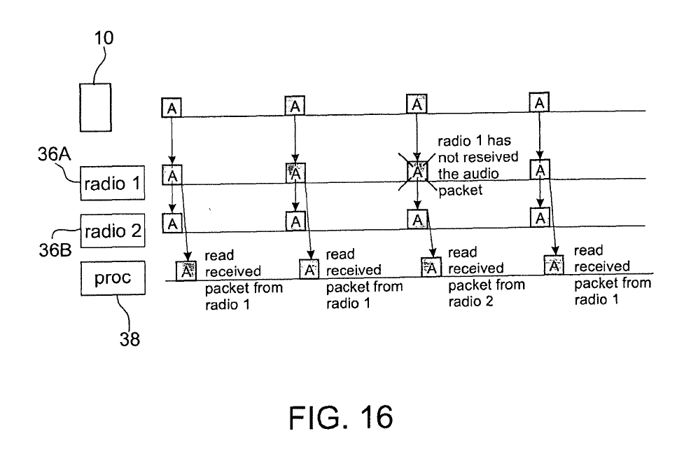

According to the variant of the relay unit 15 shown in FIG. 4 (FIG. 4 does not illustrate the multiple audio streams supplied to the mixing unit 38 as shown in FIG. 3), antenna diversity may be implemented in the relay unit 15. To this end, the relay unit 15 may comprise two separate antennas 34A, 34B, wherein the first antenna 34A is connected to a first transceiver 36A, and the second antenna 34B is connected to a second transceiver 36B. The transceiver 36A includes a buffer 37A, and the transceiver 36B includes a buffer 37B. The two parallel transceivers 36A, 36B may be utilized for applying a packet level diversity scheme to the signals received via the digital link 12, as will be explained below in more detail with regard to FIGS. 15 and 16.

The two spaced apart antennas 34A, 34B also may be used to implement antenna diversity when the relay unit 15 is transmitting. To this end, the transceivers 36A, 36B are adapted to transmit a certain audio data packet via the first antenna 34A only and to transmit subsequently a repeated copy of the same audio data packet via the second antenna 34B only.

Details of the protocol of the digital link 12 will be discussed by reference to FIGS. 9 to 12. Typical carrier frequencies for the digital link 12 are 865 MHz, 915 MHz and 2.45 GHz, wherein the latter band is preferred. Examples of the digital modulation scheme are PSK/FSK (Pre-shared key/Frequency Shift Keying), ASK (Amplitude-shift keying) or combined amplitude and phase modulations, such as QPSK (Quadrature Phase Shift Keyed), and variations thereof (for example, GFSK (Gaussian Frequency-Shift Keying)).

The preferred codec used for encoding the audio data is ADPCM (Adaptive Differential Pulse-Code Modulation).

In addition, packet loss concealment (PLC) may be used in the receiver unit. PLC is a technique which is used to mitigate the impact of lost audio packets in a communication system, wherein typically the previously decoded samples are used to reconstruct the missing signal using techniques such as wave form extrapolation, pitch synchronous period repetition and adaptive muting.

As already mentioned, data transmission occurs in the form of TDMA frames comprising a plurality (for example, 10) of time slots, wherein in each slot one data packet may be transmitted. In FIG. 9 an example is shown wherein the TDMA frame has a length of 4 ms and is divided into 10 time slots of 400 μs, with each data packet having a length of 160 μs.

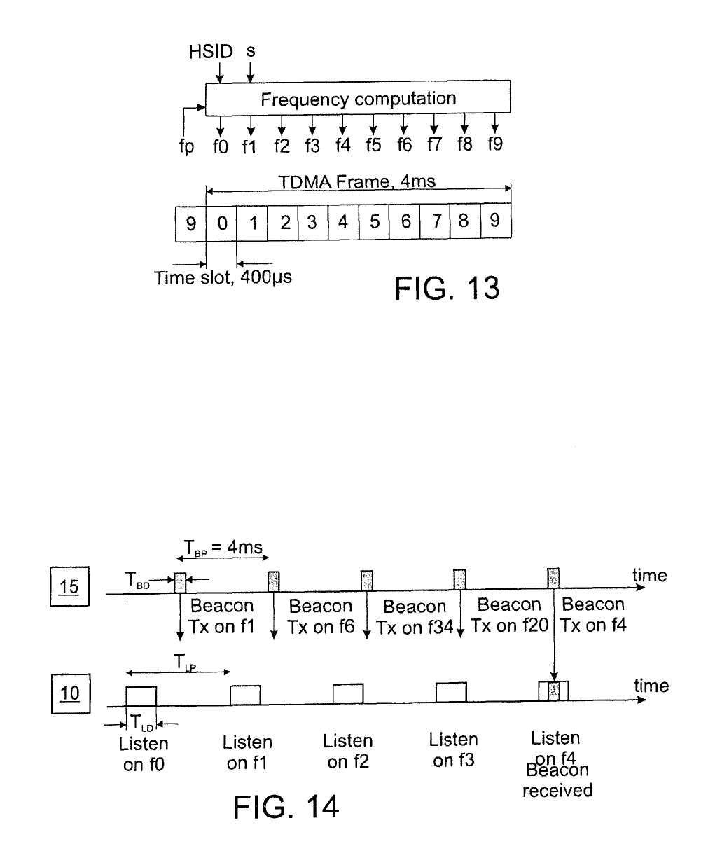

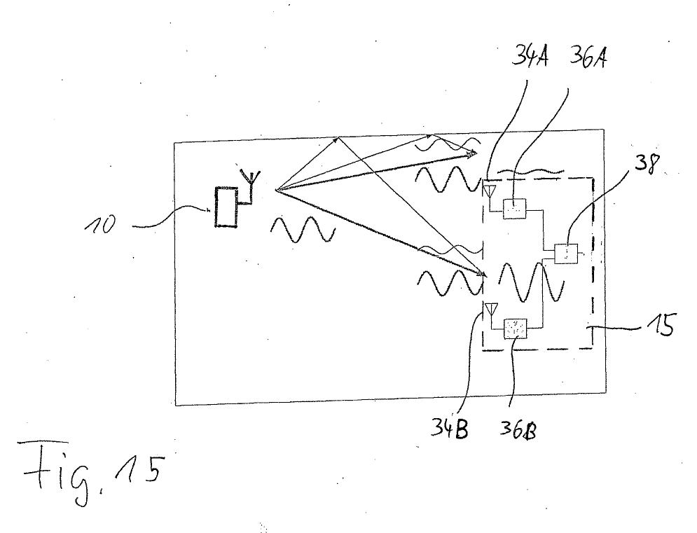

As will be explained by reference to FIGS. 13 and 14 below, preferably a slow frequency hopping scheme is used, wherein each slot is transmitted at a different frequency according to a frequency hopping sequence calculated by a given algorithm in the same manner by the transmission units 10, the relay unit 15 and the receiver units 14, wherein the frequency sequence is a pseudo-random sequence depending on the number of the present TDMA frame (sequence number), a constant odd number defining the hopping sequence (hopping sequence ID) and the frequency of the last slot of the previous frame.

The first slot of each TDMA frame (slot #0 in FIG. 9) is allocated to the periodic transmission of a beacon packet which contains the sequence number numbering the TDMA frame and other data necessary for synchronizing the network, such as information relevant for the audio stream, description of the encoding format, description of the audio content, gain parameter, surrounding noise level, etc., information relevant for multi-talker network operation, and optionally, control data for all or a specific one of the receiver units.

The second slot (slot #1 in FIG. 9) may be allocated to the reception of response data from slave devices (usually the transmission units and the receiver units) of the network, whereby the slave devices can respond to requests from the master device through the beacon packet. At least some of the other slots are allocated to the transmission of audio data packets, wherein each audio data packet is repeated at least once, typically in subsequent slots. In the illustrative example shown in FIGS. 9 and 10 slots #3, 4 and 5 are used for threefold transmission of a single audio data packet. The transmitting device (i.e., one of the transmission units 10 or the relay unit 15) does not expect any acknowledgement from the receiving devices (i.e., the relay unit 15 or the receiver units 14), i.e., repetition of the audio data packets is done in any case, irrespective of whether the receiving device has correctly received the first audio data packet (which, in the example of FIGS. 9 and 10, is transmitted in slot #3) or not. Also, the receiving devices are not individually addressed by sending a device ID, i.e., the same signals are sent to all receiver units (broadcast mode).

Rather than allocating separate slots to the beacon packet and the response of the slaves, the beacon packet and the response data may be multiplexed on the same slot, for example, slot 0.

The audio data may be compressed prior to being transmitted.

If the relay unit 15 comprises two antennas 34A, 34B, packet level diversity with regard to the audio data packets may be realized on the transmitter side by transmitting each one of the copies of the same audio data packet alternatingly via a different one of the antennas 34A, 34B. For example, the first copy of the audio data packet (which, in the example of FIGS. 9 and 10, is transmitted in slot #3, may be transmitted via the antenna 34A, whereas the second copy (in slot #4) may be transmitted via the antenna 34B, while the third copy (in slot #5) may be transmitted again via the antenna 34A. If, for example, at the position of the antenna 34A multi-path fading occurs with regard to the antenna of the receiver unit 14, it is unlikely that multi-path fading likewise occurs at the position of the antenna 34B, so at least one copy will be transmitted/received without fading.

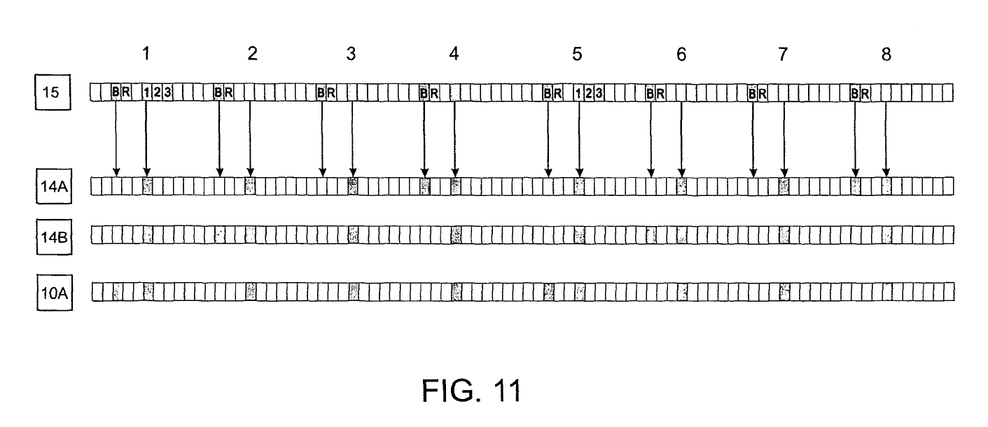

Usually, in a synchronized state, each slave listens only to specific beacon packets (the beacon packets are needed primarily for synchronization), namely those beacon packets for which the sequence number and the ID address of the respective slave device fulfills a certain condition, whereby power can be saved. When the master device wishes to send a message to a specific one of the slave devices, the message is put into the beacon packet of a frame having a sequence number for which the beacon listening condition is fulfilled for the respective slave device. This is illustrated in FIG. 11, wherein a receiver unit 14A listens only to the beacon packets sent by the relay unit 15 in the frames #1, 5, etc., a receiver unit 14B listens only to the beacon packets sent by the relay unit 15 in the frames #2, 6, etc., and a transmission unit 10A listens only to the beacon packet sent by the relay unit 15 in the frames #3, 7, etc.

Periodically, all slave devices listen at the same time to the beacon packet, for example, to every tenth beacon packet (not shown in FIG. 11).

Each audio data packet comprises a start frame delimiter (SFD), audio data and a frame check sequence, such as CRC (Cyclic Redundancy Check) bits. Preferably, the start frame delimiter is a 5 bytes code built from the 4 byte unique ID of the network master. This 5 byte code is called the network address, being unique for each network.

In order to save power, the receiver 48 in the receiver unit 14 is operated in a duty cycling mode, wherein the receiver wakes up shortly before the expected arrival of an audio packet. If the receiver is able to verify (by using the CRC at the end of the data packet), the receiver goes to sleep until shortly before the expected arrival of a new audio data packet (the receiver sleeps during the repetitions of the same audio data packet), which, in the example of FIGS. 9 and 10, would be the first audio data packet in the next frame. If the receiver determines, by using the CRC, that the audio data packet has not been correctly received, the receiver switches to the next frequency in the hopping sequence and waits for the repetition of the same audio data packet (in the example of FIGS. 9 and 10, the receiver then would listen to slot #4 as shown in FIG. 10, wherein in the third frame transmission of the packet in slot #3 fails).

In order to further reduce power consumption of the receiver, the receiver goes to sleep shortly after the expected end of the SFD, if the receiver determines, from the missing SFD, that the packet is missing or has been lost. The receiver then will wake up again shortly before the expected arrival of the next audio data packet (i.e., the copy/repetition of the missing packet).

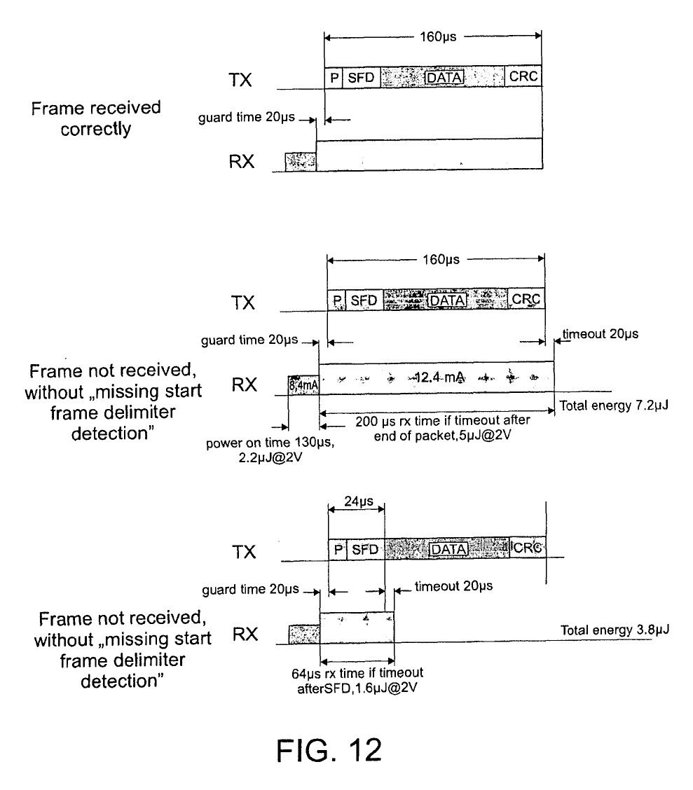

An example of duty cycling operation of the receiver is shown in FIG. 12, wherein the duration of each data packet is 160 μs and wherein the guard time (i.e., the time period by which the receiver wakes up earlier than the expected arrival time of the audio packet) is 20 μs and the timeout period (i.e., the time period for which the receiver waits after the expected end of transmission of the SFD and CRC, respectively) likewise is 20 μs. It can be seen from FIG. 12 that, by sending the receiver to sleep already after timeout of the SFD transmission (when no SFD has been received), the power consumption can be reduced to about half of the value when the receiver is sent to sleep after timeout of CRC transmission.

As already mentioned above, a pseudo-random frequency hopping scheme is used for data transmission. As illustrated in FIG. 13, for calculating the frequency-hopping sequence an algorithm is used, which has as input parameters the frequency fₚ used for the last slot of the previous frame, the hopping sequence ID (HSID) and the sequence number s of the present frame. The algorithm uses a linear congruent generator (LCG) which outputs the frequency for each slot of the frame based on these three input parameters. An example of the computation of fᵢ,iε{0; 9}, based on the three parameters HSID, s and fₚ are given below:

### Initialisation of constants

c=HSID

m=2¹⁶

r=s

### Computation of f₀ based on fₚ

r=mod(17·r+c,m)

\hat{r}=(19·r)/2¹⁶

f₀=mod(fₚ₊11+\hat{r},40)

### Computation of f_{1,} f_{2, . . . ,}f₉ for each f_{i,}iε{1.9}

r=mod(17·r+c,m)

\hat{r}+(19·r)/2¹⁶

fᵢ=mod(fᵢ₋₁+\hat{r},40)

The information necessary to compute the frequency-hopping sequence for the present frame is transmitted in the beacon packet in the first slot of the frame from the master device to the slave devices. The Hopping Sequence ID is not included in the beacon packet, but rather is transmitted in a pairing phase to the slave devices and is stored in each slave device. Once synchronized to the master device, the slave devices increment the sequence number automatically to calculate the frequency at which the beacon packet of the next frame is to be received.

The Hopping Sequence ID is chosen as an odd number between 1 and 65535 . . . . This number is chosen randomly by the network master (relay unit 15) and transmitted to the network slaves (transmission units 10 and receiver units 14) during pairing. This odd number is used as the additive term of the LCG. By selecting the hopping sequence ID randomly, it is provided that the hopping sequence is likely to be unique to the present network, so that there is only low cross-correlation with the hopping sequence of another network which may exist, for example, in the same building. In the unlikely event that two networks select the same hopping sequence ID and disturb each other, a new pairing process in one of the network is likely to result in a different hopping sequence ID. The use of the frequency of the last slot of the previous frame in the hopping sequence algorithm ensures that there is always a minimum distance between two subsequent slots, namely also between the last slot of the previous frame and the first slot of the present frame.

Preferably, the frequency-hopping scheme is an adaptive frequency-hopping scheme, wherein packet error rate measurements are made for the used frequencies and wherein the master device may decide, based on such measurements, that a sub-set of the available frequencies should be declared as “bad frequencies” and should not be used any longer. If then the frequency computation algorithm selects one of the bad frequencies, a frequency is pseudo-randomly selected instead, from a set of frequencies composed of all “good frequencies” at the exception of the good frequency used in the preceding slot. Removing the frequency used in the preceding slot from the set of potential replacement frequencies presents the advantage of avoiding the possibility of using the same frequency twice in consecutive slots.

FIG. 14 illustrates how synchronization between the master device (for example, the relay unit 15) and the slave devices (for example, one of the receiver units 14 or one of the transmission units) may be achieved.

The synchronization is passive in the sense that there is no feedback from the slave device to the master device during synchronization. Usually, the master device, e.g., the relay unit 15, does not distinguish whether a certain one of the slaves, e.g., the receiver units 14 or transmission units 10, is in still a synchronization mode or already in a synchronized mode, so that the transmission operation of the master is always the same, i.e., the same algorithm for determining the hopping sequences is used and the same protocol is used, e.g., beacon packet in the first slot, audio data packets in some of the other slots (as long as audio signals are generated in/supplied to the transmission unit; the audio data packets are not shown in FIG. 14).

Thus, the master device transmits a beacon packet in regular intervals, namely in the first slot of each TDMA frame (according to the example, a beacon packet is sent every 4 ms). The frequency at which the respective beacon packet is sent is calculated according to the same pseudo-random hopping-sequence algorithm which is used for transmitting audio packets in the synchronized state. The hopping sequence is long in the sense that it is much longer/larger than the number of frequency channels (for example, a sequence of the length 100 is likely to show a bad correlation with another sequence of the length 100, depending on the time shift). The slave device listens periodically for the first beacon packet for synchronization, i.e., it is operated in a duty cycling mode. The listening time period is longer than the duration of the beacon packet. Each listening period is performed at a different frequency; for example, the first listening period may at the lowest frequency of the available band (i.e., the receiver listens in the lowest one of the frequency channels), and then, the listening frequency is increased for each subsequent listening period (thereby going systematically through all frequency channels). After each listening period the receiver goes back to sleep.

The periodicity of the listening periods is chosen close to the beacon packet transmission periodicity (i.e., the frame length), but it is not exactly equal, in order to have a drift between the beacon packet transmission phase and the listening phase. Due to this drift the listening phase is periodically in phase with the transmission of the beacon packet for a defined duration. When the beacon packet is transmitted at the same frequency as the one used presently for listening, synchronization is achieved and the receiver switches into the synchronized mode/state, wherein it can calculate the hopping sequence presently used by the transmission unit from the information included in the received beacon packet (i.e., the frame sequence number) and the Hopping Sequence ID stored in the receiver unit from the pairing phase. A more detailed explanation of this synchronization method is given below.

When a receiver is in the synchronization phase, it listens periodically with period T_{ListenPeriod} for a duration T_{ListenDuration} at a given frequency and then goes back to sleep. The frequency is changed for each listening phase starting with frequency number 0, and incrementing up to, e.g., frequency 39. The beacon is transmitted on any of the 40 frequencies, following the pseudo-random frequency selection.

The period T_{ListenPeriod} is chosen to be close to the beacon transmission period T_{BeaconPeriod}, but not to be exactly equal. The difference ΔT=|T_{ListenPeriod}−T_{BeaconPeriod}| causes a drift between the beacon packet transmission phase and the listening phase. Due to this drift, the listening phase is periodically in phase with the transmission of the beacon packet for a defined duration. If the beacon packet is transmitted at the same frequency as the one used for listening, synchronization is achieved. This mechanism is illustrated in FIG. 14.

The values of parameters T_{ListenPeriod}, T_{ListenDuration} are to be chosen based on the beacon packet period T_{BeaconPeriod} and on the beacon packet duration T_{BeaconDuration} as a trade-off between the synchronization delay and the synchronization power consumption.

With T_{ListenPeriod}=T_{BeaconPeriod}(1+θ), ΔT=T_{BeaconPeriod} is the shift in phase of the listening activity for every transmission of the beacon packet.

T_{ListenDuration} must be larger than T_{BeaconDuration} such that it is possible to receive a beacon packet. An additional margin ΔT is required such that the listen window is open for the duration of the beacon packet transmission, given the fact that the listen window is drifting compared to the transmission window. A larger margin than ΔT gives the opportunity for the reception of more than one beacon packet in a given transmission window.

The time interval between two in-phase periods will be

$$\begin{matrix}{T}_{InPhasePeriod} = \frac{{T}_{BeaconPeriod} {T}_{ListenPeriod}}{Δ T} \\ = \frac{{T}_{BeaconPeriod} {T}_{ListenPeriod}}{θ {T}_{BeaconPeriod}} \\ = \frac{{T}_{ListenPeriod}}{θ} \\ = {T}_{BeaconPeriod} \frac{1 + θ}{θ}\end{matrix}$$

When the transmission and listening intervals are in phase, there will be enough time for a limited number of transmission trials, until the windows are out of phase again. The number of possible trials is given by

$${N}_{TrialInPhase} = ⌊ \frac{{T}_{ListenDuration} - {T}_{BeaconDuration}}{Δ T} ⌋ ,$$

where [symbol] means rounded to the nearest integer towards zero.

The average synchronization delay can then be computed with

$${\overline{T}}_{Synchronization} = \frac{{T}_{InPhasePeriod} / {N}_{TrialsInPhase}}{1 / {N}_{Channels}} .$$

When N_{Channels}=40, θ=0.01, T_{BeaconPeriod}=4 ms, T_{ListenDuration}=600 μs, then T̅_{Synchronization}=1.6 s and the duty cycle ηwill be, in this case,

$$η = \frac{{T}_{ListenDuration}}{{T}_{ListenPeriod}} = \frac{600}{4000} = 15 \% .$$

A further refinement can be obtained if relay unit 15 has two radios, i.e., transceivers. In such case, the two radios may be used to transmit the beacon messages in an inter-leaved manner, or in parallel and at different frequencies. This method would reduce the synchronization time required at the receiver side.

As illustrated in FIG. 15 (wherein some of the elements of relay unit 15 have been omitted), by using two spaced-apart antennas 34A, 34B multi-path fading resulting from destructive interference between several copies of the same signal travelling due to multiple reflections along different signal paths with different lengths (for example, direct signal and signal reflected once), can be mitigated, since the interference conditions are different at different positions, i.e., if destructive interference occurs at the position of one of the antennas, it is likely that no destructive interference occurs at the position of the other antenna. In other words, if the two antennas are sufficiently spaced-apart, the fading events are uncorrelated on both antennas.

This effect may be utilized by applying a packet level diversity scheme in the relay unit 15. When a data packet has been received by the transceiver 36A, it will be verified by using the CRC and it will be buffered in the buffer 37A. In addition, an interrupt request is sent from the transceiver 36A to the mixing unit 38 (in the diversity embodiments shown in FIGS. 4 and 15 the mixing unit 38 also acts a processing unit for managing packet level diversity), in order to indicate that a packet has been received. The other transceiver 36B acts in parallel accordingly: when it receives a data packet, it verifies the data packet and buffers it in the buffer 37B and sends an interrupt request to the processing unit 38.

When the mixing unit 38 receives such an interrupt request, it reads the data packet from one of the two buffers 37A and 37B (usually there is a default setting from which one of the buffers the mixing unit 38 tries to read the data packet first) and flushes the other one of the buffers 37A, 37B, if the data packet was obtained correctly (rather than using interrupt requests, the respective buffer 37A, 37B could be checked at the end of the last reception slot; i.e., the receivers could operated via polling rather than via interrupts). However, if it is not possible to read the data packet from the default one of the buffers (usually because the respective antenna 34A, 34B suffered from severe multi-path fading at the reception time), the mixing unit 38 tries to read the data packet from the other one of the buffers and, if it is successful in reading the data packet, it flushes the buffer of the other.

An example of this method is illustrated in FIG. 16, wherein it is assumed that the third transmission of the data packet “A” from the transmission unit 10 fails at the antenna 34A allocated to the transceiver 36A, so that, in this case, the mixing unit 38 reads the data packet from the buffer 37B of the transceiver 36B rather than from the buffer 37A of the transceiver 36A (which, in the example, is the default receiver). Typically, such packet level diversity is applied not only to the audio data packets, but also to other data packets.

While various embodiments in accordance with the present invention have been shown and described, it is understood that the invention is not limited thereto, and is susceptible to numerous changes and modifications as known to those skilled in the art. Therefore, this invention is not limited to the details shown and described herein, and includes all such changes and modifications as encompassed by the scope of the appended claims.

1. A system for providing hearing assistance to at least one user, comprising:
a wireless digital audio link
a plurality of transmission units, each of which comprises a microphone arrangement for capturing audio signals and a digital transmitter for applying a digital modulation scheme in order to transmit the audio signals as audio data packets via the wireless digital audio link;
at least one receiver unit to be worn at or at least in part in an ear of at least one user;
a relay unit, comprising a mixing unit for mixing audio signals received from the transmission units into a mixed audio signal and at least one digital transceiver for receiving audio signals from the transmission units via the digital audio link and for transmitting the mixed audio signal to the at least one receiver unit via the wireless digital audio link as audio data packets, the at least one receiver unit comprising a digital receiver for reception of audio signals from the relay unit via the digital audio link;
means for stimulating hearing of the at least one user according to audio signals supplied from the at least one receiver unit;
wherein the relay unit and each transmission unit are adapted to transmit each audio data packet in at least one allocated separate slot of a TDMA frame at a different frequency according to a frequency hopping sequence.

2. The system of claim 1, wherein the TDMA frames are structured for unidirectional broadcast transmission of the audio data packets from the relay unit, without individually addressing the receiver unit.

3. The system of claim 2, wherein the mixing unit is adapted to transmit each of the audio packets of the mixed audio signal at least twice in a same TDMA frame, without expecting acknowledgement messages from the at least one receiver unit.

4. The system of claim 1, wherein the TDMA frames are structured for unidirectional broadcast transmission of the audio data packets from the transmission units, without individually addressing the relay unit.

5. The system of claim 4, wherein the each of transmission units is adapted to transmit each of the audio packets at least twice in a same TDMA frame, without expecting acknowledgement messages from relay unit.

6. The system of claim 2, wherein the each of transmission units is adapted to transmit a same audio packet at least twice in subsequent slots.

7. The system of claim 3, wherein each audio data packet comprises a start frame delimiter (SFD), audio data and a frame check sequence (CRC), and wherein the digital receiver of the at least one receiver unit and each digital transceiver of the relay unit is adapted to verify each received data packet by using the frame check sequence and to use audio data of a first verified version of each data packet as the signal to be supplied to the stimulation means or the mixing unit, respectively, while not using audio data of other versions.

8. The system of claim 1, wherein the relay unit is adapted to act as a master device and the transmission units and the at least one receiver unit act as slave devices.

9. The system of claim 8, wherein in the first slot of each frame is formed as a beacon packet which contains information for hopping frequency synchronization.

10. The system of claim 9, wherein each beacon packet includes at least one of information relevant for an audio stream, from at least one of the group comprising a description of encoding format, description of audio content, a gain parameter, surrounding noise level; information relevant for multi-talker network operation, and control data for at least one of a specific one of the receiver units and/or the transmission units.

11. The system of claim 1, wherein each transmission unit is adapted to be worn by a different speaker for capturing the voice of a respective one of the speakers.

12. The system of claim 1, wherein the transmission units and the relay unit are adapted to establish the digital audio link at a carrier frequency in a 2.4 GHz ISM band.

13. The system of claim 1, wherein at least one of the receiver units is connected to or integrated into an ear-worn device, comprising the stimulation means.

14. The system of claim 1, wherein the transmission units are constructed for being worn below the respective speaker's neck.

15. The system of claim 1, wherein the at least one receiver unit includes one of the transmission units, thereby forming a transceiver unit, wherein the digital transmitter of the transmission unit and a digital receiver of the receiver unit are formed by a common digital transceiver.

16. The system of claim 15, wherein the microphone arrangement comprises two microphones, one of which is for exploiting bone conduction.

17. The system of claim 16, wherein the transceiver unit is adapted to use a Blind-Source-Separation algorithm for capturing a speaker's voice.

18. The system of claim 1, wherein the relay unit is adapted to produce the mixed audio signals as a weighted sum of the received audio signals.

19. The system of claim 18, wherein the relay unit comprises an analyzer unit for analyzing the received audio signals in order to determine the extent to which each of the audio signals is to be weighted.

20. The system of claim 19, wherein the analyzer unit is for determining weights of the audio signals according to at least one of measurement of an average signal power of each audio signal, measurement of an SNR of each audio signal and voice activity detection.

21. The system of claim 1, wherein at least two of the receiver units are to be used as a pair for the respective user's right ear and left ear, respectively, and wherein the relay unit is adapted to mix and transmit the mixed audio signal in a manner that a different mixed audio signal is to be received by the right ear receiver unit and by the left ear receiver unit, in order to enable spatial hearing by that user.

22. The system of claim 11, wherein at least one of the transmission units comprises a voice activity detector for determining whether the speaker wearing the respective transmission unit is presently speaking, and wherein the transmitter of that transmission unit is adapted to sleep during times when it has determined that said speaker is presently not speaking and to wake up during times when it has been determined that said speaker is presently speaking.

23. The system of claim 22, wherein the transmitter of said at least one of the transmission units is adapted to also wake up at least during some times when reception of beacon packets is to be expected, in order to maintain synchronization with the master device also during times when said speaker is not speaking.

24. The system of claim 1, wherein the TDMA slots are allocated in such a manner that for each transmission unit the same number of audio data packet slots per frame is available.

25. The system of claim 1, wherein the TDMA slots are allocated in such a manner that for each transmission unit the same audio data packet slots are available in each frame.

26. The system of claim 1, wherein the TDMA slots are allocated in such a manner that for the relay unit at least the same number of audio data packet slots per frame is available as for each transmission unit.

27. The system of claim 1, wherein the slots of the TDMA frames are allocated by the relay unit by transmitting respective beacon packets.

28. The system of claim 1, wherein at least one of the TDMA slots is permanently or in a time-multiplexed manner allocated to control data packets to be sent from at least one of the receiver unit and/or the transmission units to the relay unit.

29. The system of claim 28, wherein the control data packets from the transmission units includes a resource request for allocation of TDMA slots for audio data packet transmission from one of the transmission units.

30. The system of claim 1, wherein the wireless audio link (12, 12′) is a main audio link, wherein the relay unit comprises a plurality of said transceivers, at least one of which is for establishing a supplementary wireless digital audio link in parallel to the wireless audio data link for transmitting audio signals as data packets from at least one of the transmission units to the relay unit, wherein the frequency hopping scheme applied to the TDMA slots of the supplementary audio link is such that the presently used frequency is always different from the frequency presently used by the main audio link, and wherein also the audio signals received via the supplementary audio link are used for producing the mixed audio signal.

31. The system of claim 30, wherein the frequency hopping scheme applied to the TDMA slots of the supplementary audio link is such that a presently used frequency corresponds to a frequency used in a previous TDMA slot of the main audio link.

32. The system of claim 1, wherein the relay unit comprises at least two of said digital transceivers, each being connected to a common processing unit and an antenna and including a demodulator and a buffer, wherein each audio data packet to be received by the relay unit comprises a start frame delimiter (SFD), audio data and a frame check sequence (CRC), wherein each transceiver is for receiving, verifying and buffering each of the audio data packets, and wherein the processing unit is adapted to read an audio data packet from the buffer of one of the transceivers and, if the packet has been correctly received by that transceiver, to flush the buffer of the other one(s) of the transceivers and, if the packet has not been correctly received by that transceiver, to read the audio data packet from the buffer of another one of the transceivers.

33. The system of claim 1, wherein each audio data packet of the mixed audio signal to be transmitted by the relay unit comprises a start frame delimiter (SFD), audio data and a frame check sequence (CRC), wherein the relay unit comprises a first antenna and a second antenna spaced apart from the first antenna, and wherein the transceiver is adapted to transmit a certain audio data packet via the first antenna only and to transmit subsequently a repeated copy of the same audio data packet via the second antenna only.

34. A method for providing hearing assistance to at least one user, comprising the steps of:
capturing audio signals at a plurality of transmission units by a microphone arrangement of the respective transmission unit;
transmitting the audio signals as data packets via a digital wireless audio link from the transmission units to a relay unit comprising at least one digital transceiver;
mixing the audio signals in the relay unit and transmitting the mixed audio signal as data packets via the digital wireless audio link to at least one receiver unit;
stimulating hearing of the at least one user according to audio signals supplied from the receiver unit;
wherein each data packet is transmitted from the relay unit and each transmission unit in at least one allocated separate slot of a TDMA frame at a different frequency according to a frequency hopping sequence.
